(19) United States
(12) Patent Application Publication
(10) Pub. No.: US 2014/0379820 A1
(43) Pub. Date: Dec. 25, 2014

(54) EMAIL ADDRESS AND TELEPHONE NUMBER UNIFICATION SYSTEMS AND METHODS

(71) Applicants: Joel M. Carson, Salt Lake City, UT (US); Michael B. Edgington, Herriman, UT (US); Craig Hutchinson, Salt Lake City, UT (US); Aaron M. Owen, Salt Lake City, UT (US)

(72) Inventors: Joel M. Carson, Salt Lake City, UT (US); Michael B. Edgington, Herriman, UT (US); Craig Hutchinson, Salt Lake City, UT (US); Aaron M. Owen, Salt Lake City, UT (US)

(73) Assignee: GMOB, LLC, Holladay, UT (US)

(21) Appl. No.: 14/116,086

(22) PCT Filed: May 4, 2012
(86) PCT No.: PCT/US2012/036628

§ 371 Date: Jun. 2, 2014

Related U.S. Application Data
(60) Provisional application No. 61/483,471, filed on May 6, 2011.

(51) Int. Cl. H04L 12/58

(52) U.S. Cl. CPC H04L 51/36; H04L 51/28
USPC 709/206

(57) ABSTRACT

Example methods and systems for associating a telephone number with an email address are disclosed. One example method includes receiving a telephone number, receiving a first email address, and associating the first email address with a second email address. At least a portion of the second email address includes the telephone number. Email messages sent to the second email address are then forwarded to the first email address.

### CROSS REFERENCE TO RELATED APPLICATIONS

This application claims benefit and priority to U.S. Provisional Application No. 61/483,471, filed on May 6, 2012, the entirety of which is incorporated herein by reference.

### BACKGROUND

The present disclosure relates to email address and telephone number unification systems and methods and more particularly to email address and telephone number unification systems and methods that unify an email address with a telephone number to simplify, among other things, the process of communicating the email address to others.

Currently, existing email providers typically cannot provide a user with the email address the user wants. For example, the user's name is typically not unique and is usually taken when availability is determined. Accordingly, many email addresses are long strings filled with, e.g., periods, under-scores, dashes, and easily confused domain name extensions (e.g., .net/.org/.gov/.edu), etc. In short, due to limited availability of unique email addresses, many email addresses make little sense. In addition, such email addresses are difficult to remember, communicate to others, and/or add to an address book.

A telephone number, on the other hand, is unique to a particular person and is more easily remembered, communicated, and recorded. However, telephone communications are not as versatile or flexible as email communications. For example, although a smart phone can send and receive text messages, the size and content of such messages is limited. Moreover, in many cases, a smart phone user must use the text message management interface provided by the smart phone vendor and may not have the option of using a desired email provider interface, such as that of Gmail, Yahoo, MSN/Hotmail, Outlook, Thunderbird, or other email provider software, for managing their messages.

### SUMMARY

In general, embodiments described herein relate to methods and systems for unifying an email address and a telephone number. Example email address and telephone number unification systems permit, for example, using a telephone number to conveniently and simply communicate an email address associated with any desired email provider.

A first general aspect described herein is a method for associating a telephone number with an email address. The method includes receiving a telephone number, receiving a first email address, and associating the first email address with a second email address. At least a portion of the second email address includes the telephone number.

A second general aspect described herein is a method for forwarding messages associated with a telephone number to an email address. The method includes sending a web link to a telecom device, the web link authenticating a telephone number of the telecom device. If the telephone number is authenticated, the user may be prompted for entry of a first email address. The first email address may then be received and associated with the telephone number. When a message associated with the telephone number is subsequently received, the received message may be forwarded to the first email address associated with the telephone number.

A third general aspect described herein is a method for forwarding messages associated with a telephone number to an email address. The method includes receiving an email message addressed to a first email address, the first email address identifying a telephone number. In response to receiving the message, the received message may be forwarded to a second email address associated with the telephone number.

A fourth general aspect described herein is a method for forwarding messages associated with a telephone number to an email address. The method includes at a server, receiving a message addressed to a telecom device, and, in response to receiving the message, forwarding the received message to an email address associated with the telecom device.

A fifth general aspect described herein is a system for associating a telephone number with an email address. The system includes a first server and a second server. The first server may be configured to receive a telephone number, receive a first email address, and associate the first email address with a second email address. At least a portion of the second email address may include the telephone number. The second server may be configured to forward messages addressed to the second email address to an email server providing service for the first email address.

A sixth general aspect described herein is a system for forwarding messages associated with a telephone number to an email address. The system comprises a first server and a second server. The first server may be configured to send a web link to a telecom device, the web link authenticating a telephone number of the telecom device, request entry of a first email address if the telephone number is authenticated, and receive the first email address and associate the first email address with the telephone number. The second server may be configured to receive a message associated with the telephone number, and in response to receiving the message, forward the received message to the first email address associated with the telephone number.

A seventh general aspect described herein is one or more computer storage media having stored thereon computer executable instructions that, when executed by at least one processor of a computer system, implement a method for forwarding messages associated with a telephone number to an email address. The method includes receiving an email message addressed to a first email address. The first email address may identify a telephone number. In response to receiving the message, the received message may be forwarded to a second email address associated with the telephone number.

Additional features described herein will be set forth in the description which follows, and in part will be obvious from the description, or may be learned by the practice of the invention. The features described herein may be realized and obtained by means of the instruments and combinations particularly pointed out in the appended claims. These and other features described herein will become more fully apparent from the following description and appended claims, or may be learned by the practice of these concepts as set forth hereinafter.

### BRIEF DESCRIPTION OF THE DRAWINGS

To further clarify the above and other features described herein, a more particular description will be rendered by reference to specific embodiments thereof which are illustrated in the appended drawings. It is appreciated that these drawings depict only typical embodiments of the invention and are therefore not to be considered limiting of its scope. Embodiments of the invention will be described and explained with additional specificity and detail through the use of the accompanying drawings in which:

FIG. 1 shows an example computer system for forwarding messages associated with a telephone number to an email address;

FIG. 2 shows an example system in which telephone numbers may be associated with email addresses;

FIG. 3 shows a first example interface screen presented to a user by an account registration server in the system of FIG. 2;

FIG. 4 shows a second example interface screen presented to a user by an account registration server in the system of FIG. 2;

FIG. 5 shows a third example interface screen presented to a user by an account registration server in the system of FIG. 2;

FIG. 6 shows a fourth example interface screen presented to a user by an account registration server in the system of FIG. 2;

FIG. 7 shows an example method for forwarding messages to an email address associated with a telephone number; and

FIG. 8 shows an example system in which the method of FIG. 7 may be performed.

FIG. 9 shows an example method for associating telephone numbers with email addresses.

### DETAILED DESCRIPTION

Reference will now be made to the figures wherein like structures will be provided with like reference designations. It is understood that the figures are diagrammatic and schematic representations of presently preferred embodiments of the invention, and are not limiting of the present invention, nor are they necessarily drawn to scale.

Embodiments of systems and methods described herein provide, among other things, simple and convenient methods and systems for email address and telephone number unification. According to one example method, any desired email address (i.e. a “first” email address), such as john_smith1234.abcd@somedomain.net, is associated with another email address (i.e., a “second” email address) that includes a telephone number in a portion thereof (e.g., 9995551212@gmob.com). According to an example embodiment, the first email address may be selected by a user of the telephone number and any email that is addressed to the second email address will be forwarded to the first email address that the user selected. Consequently, a user may continue using their current preferred email provider and its associated email address to receive email without worrying about how complex or convoluted their email address is. Instead, the user may simply tell their new contacts to use an email address that is based on their more easily remembered and communicated telephone number. For example, instead of spelling out a long and convoluted email address, a user may instead indicate to contacts that his/her email address is his/her telephone number at gmob.com.

Moreover, according to certain embodiments of the invention, the only limit imposed on email size is that of the email provider associated with the first email address. The server that forwards emails may be configured to allow reception and forwarding of any size email. In addition, because telephone numbers are unique identifiers of individuals, availability of the second email address can be guaranteed. To guarantee availability, an authentication procedure may be carried out each time an email address is associated with a telephone number. Furthermore, not only does a telephone number uniquely identify an individual, it is persistent like a fingerprint because telephone numbers may now be ported at no cost when a user changes telecom service providers.

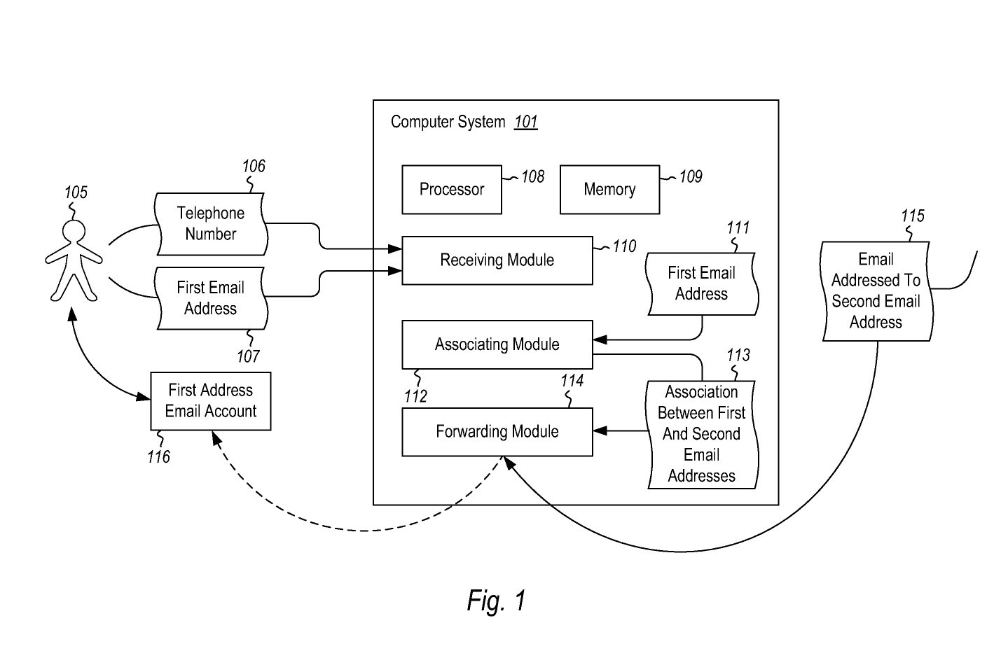

FIG. 1 shows a computer system 101 for forwarding messages associated with a telephone number to an email address. The computer system includes at least one processor 108 and some portion of system memory 109. The computer system 101 also includes modules for performing various functionality including receiving data. For example, receiving module 110 may receive telephone number 106 and first email address 107 from user 105. The telephone number 106 corresponds to the user's telephone, and the first email address 107 corresponds to the user's existing email account (as explained above). The associating module 112 may be configured to associate a second email address 111 with the first email address 107, such that messages send to the second email address 111 are forwarded to the email account 116 of the first email address. The second email address may include user 105's telephone number 106 as the local portion of the email address. Forwarding module 114 may access an association between the first and second email addresses 113 to determine where to forward any messages addressed to the second email address 115. Thus, upon receiving message 115, the forwarding module 114 forwards the received message to the first email address (and thus to the first email address email account 116).

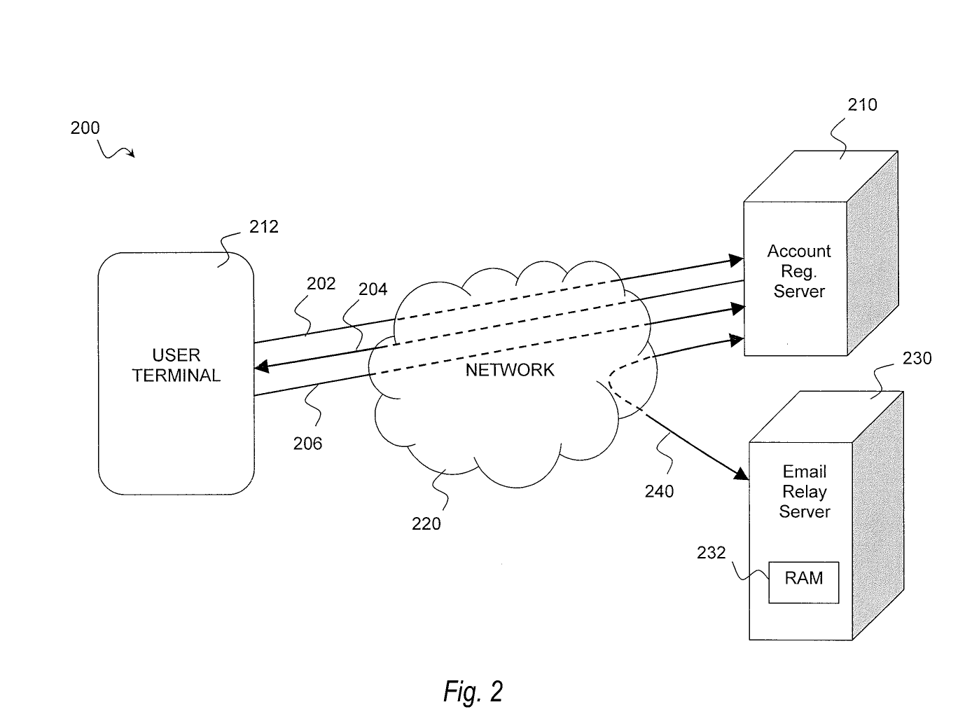

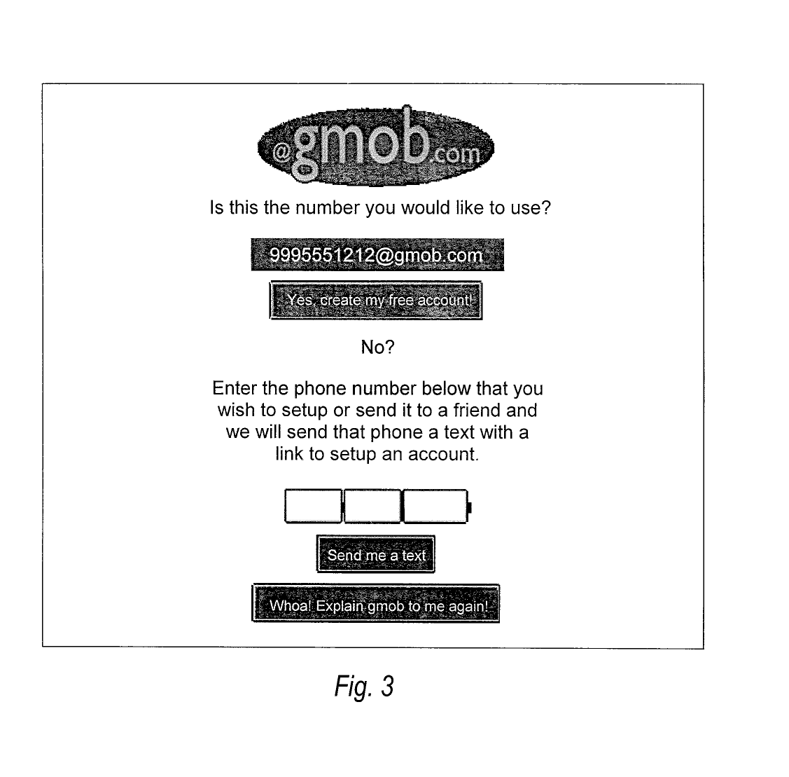

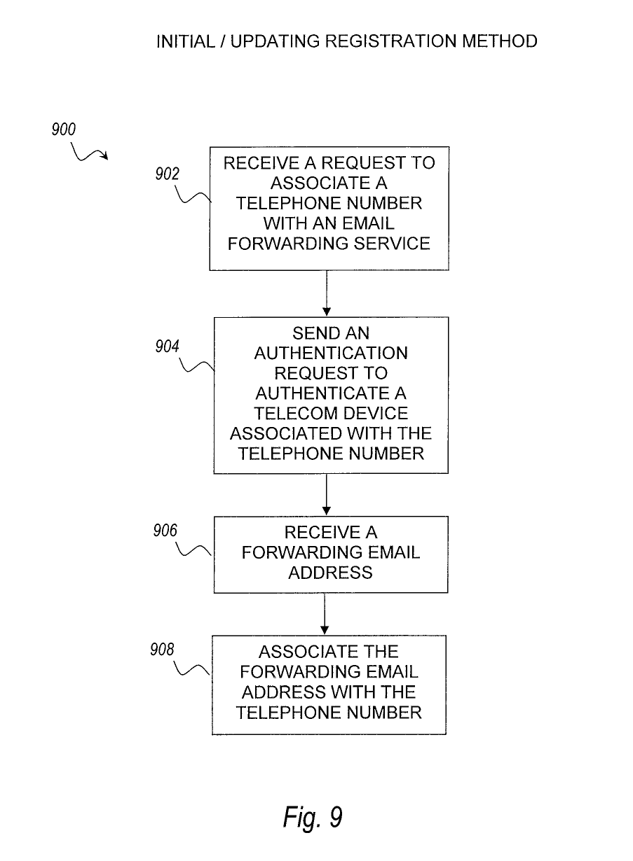

FIG. 2 illustrates a system in which telephone numbers may be associated with email addresses. FIG. 9 illustrates a method 900 for registering a user's telephone number with a forwarding email address. Method 900 will be discusses with reference to the system 200 of FIG. 2. FIGS. 3-5 show example interfaces presented to a user to associate a telephone number with an email address. Networks described herein may be part of or connected to the Internet, and may include communication channels to mobile and/or stationary telecom devices. Moreover, user terminals described herein may be any telecom device, such as a mobile smart phone, a stationary desktop computer, a laptop computer, a netbook, a tablet computer, a wireless mp3 player, or the like.

At stage 902, an account registration server 210 receives a request from a user to associate a telephone number 106 belonging to the user with an email forwarding service. As represented by a first arrow 202 in FIG. 2, the request may be received from a user terminal 212 via one or more channels in a network 220.

Next, at stage 904, an authentication request is sent by account registration server 210 to a telecom device associated with the telephone number 106. The authentication request is represented by a second arrow 204 in FIG. 2 from account registration server 210 to user terminal 212. For example, account registration server 210 may use the telephone number 106 to send a web link encoding the telephone number 106 to the telecom device to which the telephone number is assigned. The telecom device may be user terminal 212, as shown in system 200 of FIG. 2, or some other device (not shown). In another example, the user terminal 212 may be a separate device from the telecom device. In other words, the user may access the user terminal 212 for some aspects of method 900 and a separate telecom device for other aspects of method 900 (such as authentication of the telephone number 106).

As another example of authentication, account registration server 210 may automatically generate an identification code, such as a random string of alphanumeric characters, and may send a message including the identification code to user terminal 212. The message may indicate that a telephone call will be made to the telecom device (which may or may not be user terminal 212) to which the telephone number 106 is assigned and that entry of the identification code will be requested for authentication purposes. Then, after sending the message, account registration server 210 may automatically call the telephone number 106 and request entry of the previously transmitted identification code. The foregoing authentication methods are merely presented as examples and other forms and methods of authentication may be used. For instance, authentication may be performed using a text message or other features of the user's telecom device.

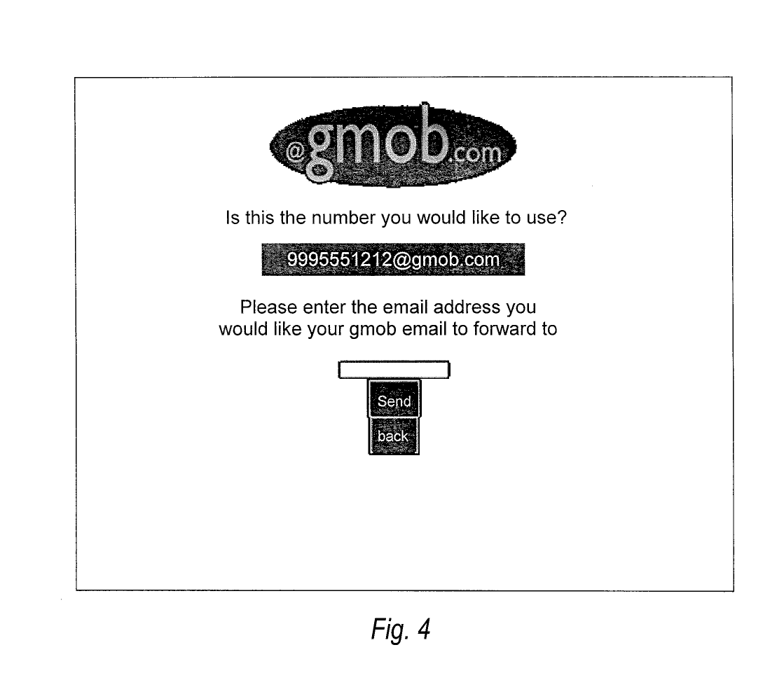

At stage 906, account registration server 210 receives an email forwarding address, which is represented by a third arrow 206 in FIG. 2. For example, if an owner or user of the telecom device that receives the web link clicks on the web link, the user may be directed to a web site presenting an interface screen that confirms whether the user wishes to use the email forwarding service. An example of such an interface screen is shown in FIG. 3. Then, if the user confirms, e.g., by clicking on a confirmation link, the user may be directed to an interface screen, such as the one shown in FIG. 4, that requests an email forwarding address from the user. Alternatively, the confirmation interface screen of FIG. 3 may be omitted and the user may be immediately directed instead to the interface screen of FIG. 4, which requests entry of the email forwarding address. The user may enter any email address, including, e.g., a work email address or the email address of a preferred email service provider with which the user is currently registered, such as Gmail, Yahoo, MSN/Hotmail, etc.

Then, at stage 908, the email forwarding address is associated with the telephone number 106, e.g., in one or more databases. This association may be performed by account registration server 210 and/or an email relay server 230 communicatively coupled, as shown by a bidirectional arrow 240, to account registration server 210. The communicative coupling may provide bidirectional communications, as shown, or one-way communications from account registration server 210 to email relay server 230. For example, in one example implementation of system 200, account registration server 210 records the association in a database and email relay server 230 monitors the database for changes and makes a corresponding change to a corresponding database or table locally accessible to email relay server 230.

For example, an email service application that performs an email forwarding function at email relay server 230 may reference a table stored in a random access memory (RAM) 232 or other volatile memory, such as one or more microprocessor registers, of email relay server 230 to determine which email forwarding addresses to use when performing email forwarding. Rather than access the volatile memory through normal operating system, an assembly language routine may directly access the volatile memory. By using volatile memory to store this information the email service application is able to perform email forwarding with minimal latency. Moreover, due to this configuration, changes to the table are made directly in the volatile memory, e.g., by an assembly language software module. Recording updates on a hard disk or some other nonvolatile storage device would require a restart of the email service application to load the changes from the hard disk into the volatile memory, thereby introducing latencies and/or service interruptions.

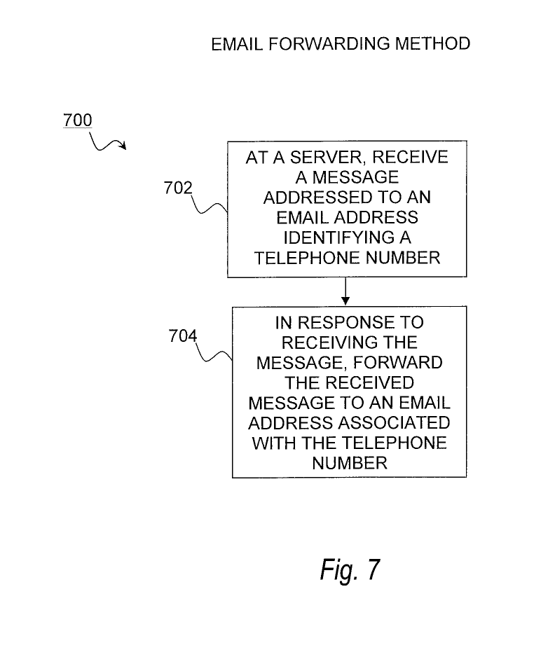

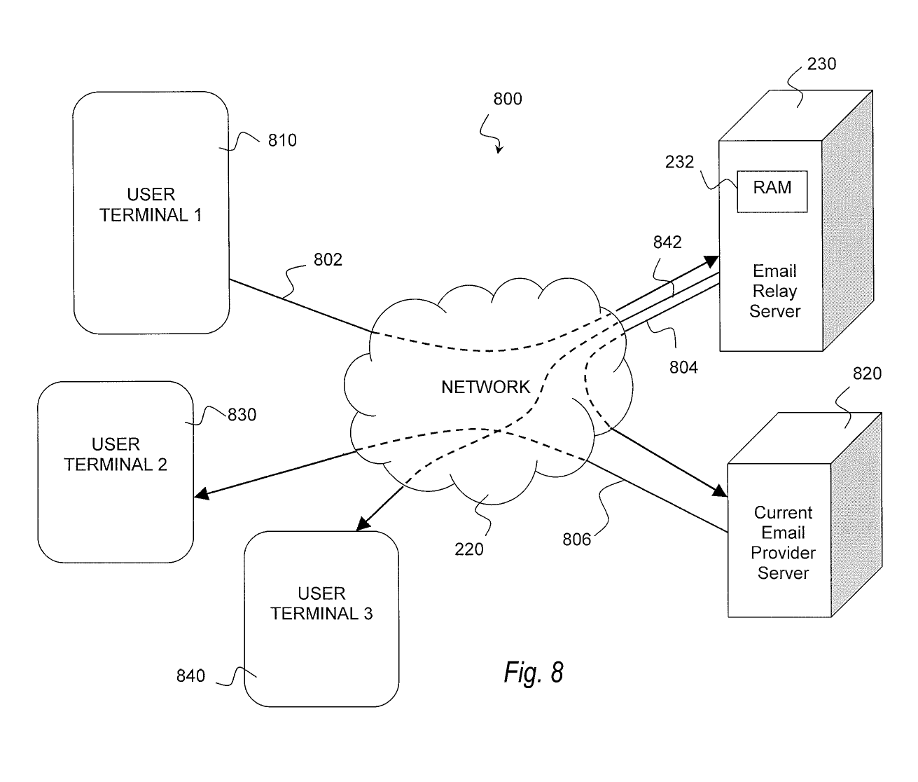

The forwarding email address may be associated with the telephone number 106 by creating a new email address at account registration server 210 that contains the telephone number 106 in a portion thereof and associating the new email address with the forwarding email address. For example, the created email address may be the telephone number 106 at a particular domain, such as number@ gmob.com. Email relay server 230 may periodically monitor for or receive indications of new email addresses created by account registration server 210. Consequently, when an email message is sent to the telephone number at the gmob.com domain (e.g., to 9995551212@gmob.com), the email service application running on email relay server 230 receives the email message, recognizes the previously registered gmob email address as being associated with the forwarding email address designated by the user, and relays email message to the forwarding email address. Additional details of the email forwarding service are described below with reference to FIGS. 7 and 8.

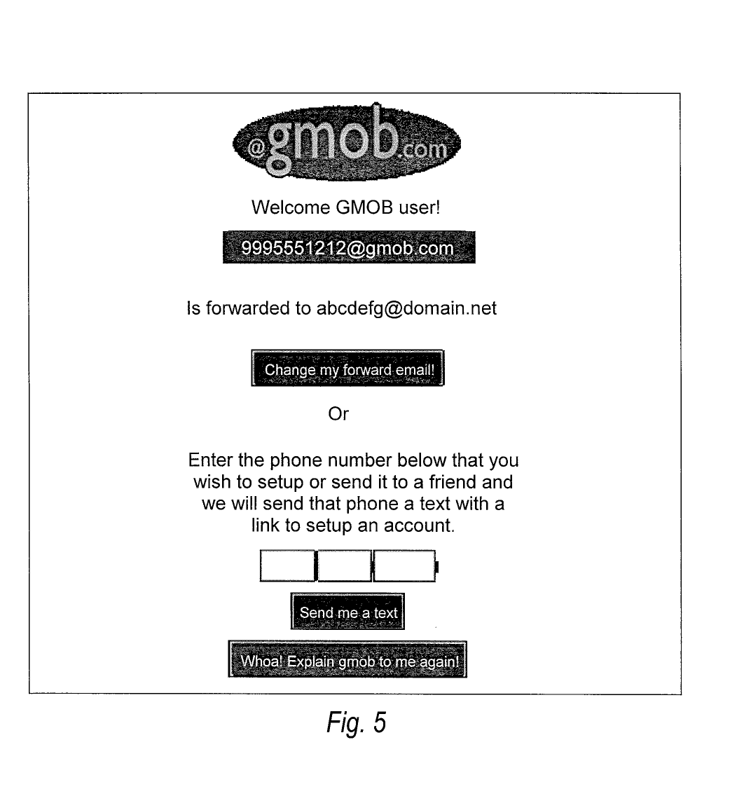

FIG. 5 shows an interface screen that may be presented after successful submission of a forwarding email address. The interface screen of FIG. 5 reports to the user that the forwarding email address is now associated with the telephone number 106. As shown in FIG. 5, the user may be queried to enter additional telephone numbers of friends who may also be interested in the email forwarding service. Upon receipt of such additional telephone number(s), account registration server 210 sends authentication request(s) similar to that of stage 904, to the additional telephone number(s) entered by the user. The remaining stages of method 900 may then be carried out to register forwarding email addresses for the users of the additional telephone number(s).

In system 200 of FIG. 2, account registration server 210 and email relay server 230 are shown as two separate servers in communication with each other via network 220. However, the two servers may be implemented as a single server or, each server may be implemented as a plurality of servers. For example, one or both servers may be cloud servers that can enlist the resources of additional cloud servers as needed to accommodate increasing loads as additional new users register and/or to accommodate service spikes.

In one embodiment, account registration server 210 is a web server that hosts a web site accessible via the Internet. Thus, at stage 902, a user may submit a registration request by sending an HTTP query to the web site hosted at account registration server 210 and the web site may prompt for entry of the user's telephone number 106. After authentication of the telephone number 106 is performed at stage 904, the web site may prompt for entry of the forwarding email address to be associated with the telephone number at stage 906.

Alternatively or in addition, account registration server 210 may be a short code server and a registration request in stage 902 may be received in the form of a text message addressed to a short code hosted by the short code server. The short code server may implement a variety of services in association with the short code, including the email forwarding registration service described herein. Therefore, the user may be instructed, e.g., by an advertisement for the email forwarding service, to send a text message from their smart phone to request the email forwarding service. The user may be further instructed to include a specific alphanumeric string in the text message, such as “gmob”, to indicate to the short code server that the email forwarding service is requested, as opposed to some other service provided by the short code server. Moreover, the short code server may be configured to automatically parse a telephone number 106 from a sending field of the message to make an initial determination of what telephone number should be associated with a forwarding email address to be entered.

Furthermore, in one embodiment, the short code server is configured to automatically parse additional information in text messages it receives. For example, in addition to recognizing a service requesting word, such as “gmob”, the short code server may be configured to recognize an email address that follows or precedes the service requesting word as the forwarding email address. Consequently, the short code server may then automatically associate the forwarding email address with the telephone number 106 in a database, as described above with respect to stage 908 of method 900. However, prior to associating the forwarding email address with the telephone number 106, authentication of the telephone number may be performed by, for example, sending a web link or identification code in a text message to a telecom device assigned to the telephone number and confirming receipt of an expected response.

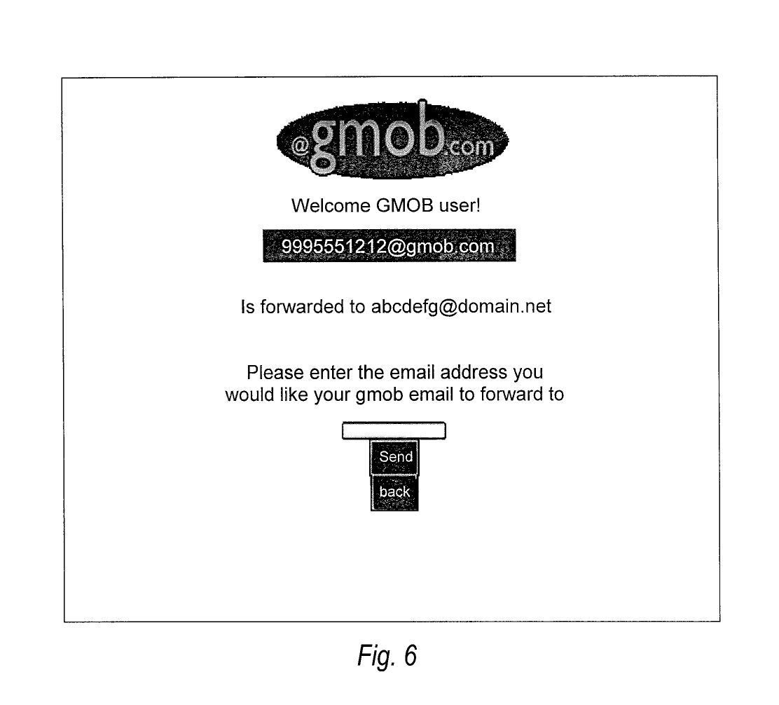

The registration method 900 may be repeated any number of times in series and/or in parallel for new users. Moreover, registration method 900, or portions thereof, may be repeated at any time for an existing user who wishes to update their forwarding email address. FIG. 6 shows an example interface screen that account registration server 210 may present when a previously registered user submits a request for the email forwarding service. As shown in FIG. 6, the user may be presented with a welcome message that shows the association of a previously registered email address with the user's telephone number 106. The interface screen also prompts the user for entry of a new forwarding email address.

Although method 900 above describes receipt of a single forwarding email address to be associated with a telephone number 106, an alternative method and system may permit entry of and association of multiple forwarding email address with a single telephone number. For example, the user may be permitted to enter any number of forwarding email address upon initial registration and may be permitted to add one or more additional forwarding email addresses at any time subsequent to initial registration. Consequently, messages sent to the telephone number 106 at the email forwarding service domain are forwarded to a plurality of forwarding email addresses.

In addition to the various alternative embodiments described above, various other versions of method 900 may be implemented including versions in which various acts are modified, omitted, or new acts added or in which the order of the depicted acts differ. For example, in one alternative embodiment, a forwarding email address entered by a user may be authenticated prior to associating it with the user's telephone number 106. The authentication of the forwarding email address may be performed by, for example, sending an email to the forwarding email address requesting confirmation that the forwarding email address should be associated with the telephone number 106.

FIG. 7 shows a method 700 for forwarding messages addressed to an email addressed registered at email relay server 230 to an associated forwarding email address. FIG. 8 shows an example system 800 in which method 700 may be performed. Therefore, in describing method 700 both FIGS. 7 and 8 and will be referenced.

At stage 702 of method 700, a message, such as an email message, is received at a server, such as email relay server 230. In FIG. 8, the receipt of the email message is represented by a first arrow 802 from a first user terminal 810. It is assumed that the message is addressed to an email address that identifies a telephone number, e.g., 9995551212@gmob.com. At stage 704, in response to receiving the message, email relay server 230 forwards the received message to a forwarding email address associated with the telephone number 106, the association having previously been recorded during a registration operation. Thus, as depicted by a second arrow 804 in FIG. 8, the forwarded email is sent to a current email provider server 820 that hosts an email service for the forwarded email address. The user to whom the message is addressed may retrieve the email from their email provider at a second user terminal 830, as depicted by a third arrow 806. If the telephone number is not recognized as being associated with a forwarding email address, email relay server 230 may be configured to reply to the message with an appropriate error message. Moreover, if the telephone number is associated with multiple forwarding email addresses, the message will be sent to additional email provider servers (not shown).

Email relay server 230 may be configured to relay messages like a solid state relay in an electrical circuit. For example, unlike typical email servers, in some embodiments email relay server 230 stores received email messages only in RAM 232 or some other volatile storage device without ever storing the messages in a nonvolatile storage device local to email relay server 230. Accordingly, email relay server 230 does not impose any limits on a size of forwarded email messages and performs the forwarding operation with minimal latency. However, email relay server 230 is not restricted to only relaying email messages. For example, in other embodiments, email relay server 230 may be configured to store received email messages in a nonvolatile storage device local to email relay server 230 for access by users of email addresses to which the email messages were sent. The storage of email messages in non-volatile memory may be performed in addition to, or as an alternative to, relaying the email messages to designated forwarding email addresses. In addition, email relay server 230 may be configured to relay a first portion of the received email messages without storing them in a nonvolatile storage device and to store a second portion, exclusive of the first portion, of the received email messages in a nonvolatile storage device. For example, email messages sent to the email address(es) of a select one or more designated users may be stored in a nonvolatile storage device for access by the designated users at any time.

FIG. 8 also depicts the transmission of a message received at email relay server 230 to a third user terminal 840 capable of receiving text messages via a fourth arrow 842. For example, in addition to forwarding messages to a designated forwarding email address, email relay sever 230 may be configured to automatically send a copy of a received message to a text message email address associated with the telephone number 106 identified in the email address of the received message. A text message email address is an email address associated with a particular text message service provider. For example, some common text message email addresses are ##########@tmomail.net (for T-mobile users) ##########@vtext.com (for Verizon users), and ##########@txt.att.net (for AT&T users). The domain of the text message email address may be determined during registration of the associated telephone number by automatically reading the domain from a text message received from the telecom device assigned to the telephone number or by requesting the domain information from the user. Although a telecom device equipped to receive messages using such text message email addresses may cut off messages that are larger than a certain size limit that text message protocols permit, the user of the telecom device is nonetheless alerted to the fact that an email has been forwarded to their preferred email service provider.

Embodiments described herein may comprise or utilize a special purpose or general-purpose computer including computer hardware, such as, for example, one or more processors and system memory, as discussed in greater detail below. Embodiments described herein also include physical and other computer-readable media for carrying or storing computer-executable instructions and/or data structures. Such computer-readable media can be any available media that can be accessed by a general purpose or special purpose computer system. Computer-readable media that store computer-executable instructions in the form of data are computer storage media. Computer-readable media that carry computer-executable instructions are transmission media. Thus, by way of example, and not limitation, embodiments described herein can comprise at least two distinctly different kinds of computer-readable media: computer storage media and transmission media.

Computer storage media includes RAM, ROM, EEPROM, CD-ROM, solid state drives (SSDs) that are based on RAM, Flash memory, phase-change memory (PCM), or other types of memory, or other optical disk storage, magnetic disk storage or other magnetic storage devices, or any other medium which can be used to store desired program code means in the form of computer-executable instructions, data or data structures and which can be accessed by a general purpose or special purpose computer.

A “network” is defined as one or more data links and/or data switches that enable the transport of electronic data between computer systems and/or modules and/or other electronic devices. When information is transferred or provided over a network (either hardwired, wireless, or a combination of hardwired or wireless) to a computer, the computer properly views the connection as a transmission medium. Transmission media can include a network which can be used to carry data or desired program code means in the form of computer-executable instructions or in the form of data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to computer storage media (or vice versa). For example, computer-executable instructions or data structures received over a network or data link can be buffered in RAM within a network interface module (e.g., a network interface card or “NIC”), and then eventually transferred to computer system RAM and/or to less volatile computer storage media at a computer system. Thus, it should be understood that computer storage media can be included in computer system components that also (or even primarily) utilize transmission media.

Computer-executable (or computer-interpretable) instructions comprise, for example, instructions which cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that various embodiments may be practiced in network computing environments with many types of computer system configurations, including personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. Embodiments described herein may also be practiced in distributed system environments where local and remote computer systems that are linked (either by hardwired data links, wireless data links, or by a combination of hardwired and wireless data links) through a network, each perform tasks (e.g. cloud computing, cloud services and the like). In a distributed system environment, program modules may be located in both local and remote memory storage devices.

Additionally or alternatively, the functionally described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), and other types of programmable hardware.

Still further, system architectures described herein can include a plurality of independent components that each contribute to the functionality of the system as a whole. This modularity allows for increased flexibility when approaching issues of platform scalability and, to this end, provides a variety of advantages. System complexity and growth can be managed more easily through the use of smaller-scale parts with limited functional scope. Platform fault tolerance is enhanced through the use of these loosely coupled modules. Individual components can be grown incrementally as business needs dictate. Modular development also translates to decreased time to market for new functionality. New functionality can be added or subtracted without impacting the core system.

The foregoing detailed description of various embodiments is provided by way of example and not limitation. Accordingly, the present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A system for forwarding messages associated with a telephone number to an email address, the system comprising:
at least one processor;
system memory;
a receiving module for receiving a telephone number and a first email address;
an associating module for associating the first email address with a second email address, at least a portion of the second email address including the received telephone number; and
a forwarding module for forwarding email messages addressed to the second email address to the first email address.

2. The system of claim 1, wherein the second email address is generated in response to receiving the first email address and the telephone number.

3. The system of claim 1, further comprising:
an authenticating module for authenticating ownership of the telephone number before receiving the first email address.

4. The system of claim 1, wherein receiving the telephone number includes:
receiving a text message from a telephone associated with the telephone number, the text message identifying the telephone number.

5. The system of claim 4, wherein the text message includes the first email address and wherein receiving the first email address includes identifying the first email address in the text message.

6. The system of claim 1, wherein receiving the first email address includes requesting, via a web page interface, entry of the first email address.

7. The system of claim 1, wherein the receiving module receives a third email address.

8. The system of claim 7, wherein the associating module associates the second email address with the third email address in addition to the first email address.

9. The system of claim 7, wherein the associating module associates the second email address with the third email address instead of with the first email address.

10. A computing system comprising:
at least one processor;
system memory;
one or more computer-readable storage media having stored thereon computer-executable instructions that, when executed by the one or more processors, causes the computing system to perform a method for forwarding messages associated with a telephone number to an email address, the method comprising the following:
sending a web link to a telecom device, the web link authenticating a telephone number of the telecom device;
if the telephone number is authenticated, prompting for entry of a first email address;
receiving the first email address and associating the first email address with the telephone number;
receiving a message associated with the telephone number; and
in response to receiving the message, forwarding the received message to the first email address associated with the telephone number.

11. The computing system of claim 10, further comprising:
receiving a request to associate the telephone number with an email forwarding service, wherein the web link is sent in response to receiving the request.

12. The computing system of claim 11, wherein the request is received from the telecom device.

13. The computing system of claim 11, wherein the request is received via a web site interface.

14. The computing system of claim 10, further comprising:
creating a second email address, at least a portion of the second email address including the telephone number,
wherein associating the first email address with the telephone number includes associating the first email address with the second email address, and
wherein receiving a message associated with the telephone number includes receiving a message addressed to the second email address.

15. The computing system of claim 14, wherein the second email address is created in response to receiving the first email address.

16. The computing system of claim 10, wherein the message is automatically forwarded without storing the message in a nonvolatile memory.

17. (canceled)

18. A method for forwarding messages associated with a telephone number to an email address, the method comprising:
at a server, receiving a first message addressed to a telecom device; and
in response to receiving the first message, forwarding the received first message to an email address associated with the telecom device.

19. The method of claim 18, further comprising:
in response to receiving the first message, automatically sending at least a portion of the first message as a text message to the telecom device.

20. The method of claim 18, wherein the message is forwarded without ever storing the first message in a nonvolatile memory of the server.

21. The method of claim 18, further comprising:
sending a second message in response to the first message, the second message designating the email address associated with the telecom device as a reply-to email address in the second message.

22-41. (canceled)
